(19) United States
(12) Patent Application Publication
(10) Pub. No.: US 2007/0158128 A1
(43) Pub. Date: Jul. 12, 2007

(54) Controlling driver behavior and motor vehicle restriction control

(75) Inventors: Rosemarie M. Gratz, Putnam Valley, NY (US); Dimitri Kanevsky, Ossining, NY (US); Alexander Zlatsin, Yorktown Heights, NY (US)

Correspondence Address: SCULLY SCOTT MURPHY & PRESSER, PC, 400 GARDEN CITY PLAZA, SUITE 300, GARDEN CITY, NY, 11530, US

(73) Assignee: International Business Machines Corporation, Armonk, NY (US)

(21) Appl. No.: 11/329,633

(22) Filed: Jan. 11, 2006

(51) Int. Cl. B62H 5/00; B60K 28/00

(52) U.S. Cl. 180/287; 180/271; 180/272; 180/282

(57) ABSTRACT

A system and method for motor vehicle restriction control enables an owner of a motor vehicle to restrict another person's use and operation of the owner's motor vehicle. The system includes a driver identification module identifying a driver operating the motor vehicle and a storage device for storing at least one restriction profile defining for the driver at least one restriction of the operation the motor vehicle. The system further includes a motor vehicle controlling device for restricting the operation of the motor vehicle according to the at least one restriction in response to the driver identification module identifying the driver.

### TECHNICAL FIELD

The invention relates generally to the field of motor vehicle control, and more particularly to a system for restricting a driver's operation of a motor vehicle.

### BACKGROUND INFORMATION

Automobile accidents typically involve, or are caused by, a person driving at a speed in excess of the posted safe speed limit. Teenagers, in particular, often exceed the posted speed limit due to inexperience, immaturity, and carelessness.

Various attempts have been made to prevent inadvertent or intentional speeding. For example, there are devices that can be installed in a car that transmit to a remote receiver what speed the car is moving. However, this solution does not prevent a driver from exceeding the posted speed limit. Some automobiles include a speed alarm or a cruise control mechanism. These devices, however, cannot be programmed in advance with the posted speed limit.

There has been some investigation into systems that include roadside devices that transmit speed limits and other information to passing vehicles. However, the infrastructure required to properly implement this type of system does not exist.

Another known device that controls a vehicle's maximum speed is a governor. A governor does not allow a vehicle to exceed a particular speed that is determined when the governor is installed. However, a governor is limited in that the once the maximum vehicle speed is set, it cannot be overridden by the driver in an emergency or by the owner of the vehicle. Further, the maximum speed that the vehicle can achieve may still exceed the safe speed limits of certain residential roads.

One speed limiting system teaches allowing a driver to input vehicle operating speed limits, but is silent on enabling an owner of a vehicle to externally or remotely input vehicle operating speed limits thereby controlling the operation of the vehicle regardless of who is driving the vehicle.

### SUMMARY OF THE INVENTION

The invention relates generally to the field of motor vehicle control, and more particularly to a system for restricting a driver's operation of a motor vehicle.

In one aspect, the invention involves a system for restricting a driver's operation of a motor vehicle. The system includes a driver identification module for identifying the driver operating the motor vehicle, a storage device for storing at least one restriction profile defining for the driver at least one restriction of the operation the motor vehicle, and a motor vehicle controlling module for restricting the operation of the motor vehicle according to the at least one restriction in response to the driver identification module identifying the driver.

In some embodiments, the driver identification module includes a biometric device, a voice recognition device, or a user interface device for entering a user name.

In other embodiments, the at least one restriction includes the maximum speed at which the motor vehicle can be operated, a time of day during which the motor vehicle can be operated, or a geographical location in which the motor vehicle can be operated.

In some embodiments, the motor vehicle controlling module includes a speed limiting device, or an ignition disabling means.

In another embodiment, the system further includes a global positioning system and an alarm. The alarm engages in response to the global positioning system determining that the motor vehicle has traveled to a restricted location. The alarm includes an audible alarm located within the motor vehicle or a wireless transmitter for transmitting a warning message to a remote wireless receiver.

In still another embodiment, the system further includes a user interface for inputting or editing the at least one restriction profile. In yet another embodiment, the system further includes an override module for overriding the at least one restriction during an emergency.

In another embodiment, the system further includes a wireless communication module for remotely inputting or editing the at least one restriction profile and for remotely overriding the at least one restriction. In still another embodiment, the system further includes a wireless communication module for enabling the driver to request that the at least one restriction be temporarily disabled. In yet another embodiment, the system further includes a distance sensor for sensing the distance between the motor vehicle and another vehicle. The speed limiting device reduces the motor vehicle speed to comply with a predetermined minimum distance restriction.

In another aspect, the invention involves a method for restricting a driver's operation of a motor vehicle. The method includes providing a driver identification module for identifying the driver operating the motor vehicle, providing a storage device for storing at least one restriction profile defining for the driver at least one restriction of the operation the motor vehicle, and providing a motor vehicle controlling module for restricting the operation of the motor vehicle according to the at least one restriction in response to the driver identification module identifying the driver.

In yet another aspect, the invention involves a program storage device readable by a machine, tangibly embodying a program of instructions executable by the machine to perform method steps for restricting a driver's operation of a motor vehicle. The method steps include providing a driver identification module for identifying the driver operating the motor vehicle, providing a storage device for storing at least one restriction profile defining for the driver at least one restriction of the operation the motor vehicle, and providing a motor vehicle controlling module for restricting the operation of the motor vehicle according to the at least one restriction in response to the driver identification module identifying the driver.

The foregoing and other objects, aspects, features, and advantages of the invention will become more apparent from the following description and from the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is an illustrative block diagram of a motor vehicle restriction control system according to one embodiment of the invention.

FIG. 2 is an illustrative block diagram of a central control unit of a motor vehicle restriction control system according to one embodiment of the invention.

FIG. 3 is an illustrative block diagram of a comparison module of a motor vehicle restriction control system according to one embodiment of the invention.

FIG. 4 is an illustrative block diagram of a rule activation module of a motor vehicle restriction control system according to one embodiment of the invention.

FIG. 5 is an illustrative flow diagram of the operation of a motor vehicle restriction control system according to one embodiment to the invention.

### DESCRIPTION

The present invention enables an owner of a motor vehicle to restrict another person's use and operation of the owner's motor vehicle. For example, the invention enables a parent to restrict their child's use of the parent's motor vehicle by limiting the functionality of the motor vehicle, such as limiting the maximum speed that the motor vehicle can reach, for example.

The motor vehicle restriction control system, in one embodiment, is implemented using a computer mounted on the dashboard of a motor vehicle, such as a touch screen, for example. In other embodiments, a CPU is installed in the motor vehicle and a user interfaces with the CPU via a laptop computer, or handheld computer connected to a communication port on the dashboard of the motor vehicle.

The motor vehicle restriction control system includes control and database functions that are implemented as software executed on the CPU and stored in a data storage unit (e.g. hard disk) in communication with the CPU. The CPU is also in communication with various electromechanical devices disposed within the motor vehicle, which are described in further detail below.

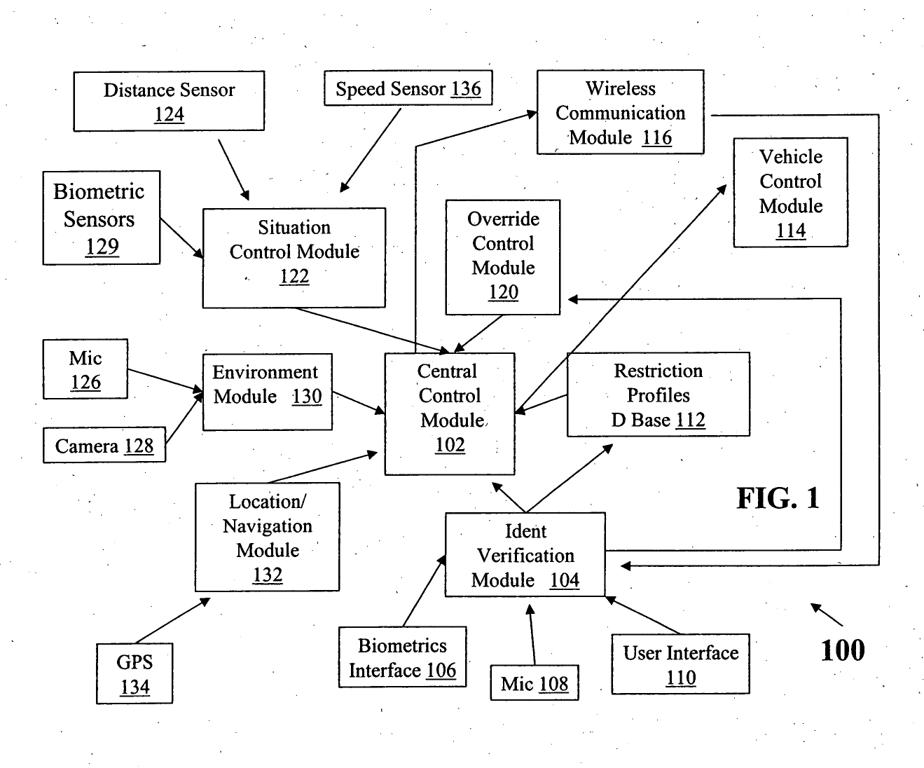

Referring to FIG. 1, in one embodiment, a block diagram of a motor vehicle restriction control system 100 is shown. The motor vehicle restriction control system 100 includes a central control unit 102. The central control unit 102 is in communication with an identification verification module 104, a location/navigation module 132, an environment module 130, a situation control module 122, an override control module 120, a vehicle control module 114, a restriction profile database 112, and a wireless communication module 116.

The identification verification module 104 is also in communication with an identity input device (e.g., biometrics interface 106, mic 108, user interface 110), the restriction profile database 112, the override control module 120, and the wireless communication module 116. In one embodiment, the identity input device is a user interface 110 for entering a simple user ID or password. In other embodiments, the identity input device is a microphone 108, or a biometric interface 106.

The situation control module 122 is in communication with a distance sensor 124, a speed sensor 136, and biometric sensor 129. The environment module 130 is in communication with a camera 128, and a microphone 126. The location/navigation module 132 is in communication with a global positioning system (GPS) 134 or like satellite-based object tracking system. Thus, preferably a GPS based receiver is located in the vehicle and is used for tracking the vehicle's current position, which can be communicated to the vehicle's owner.

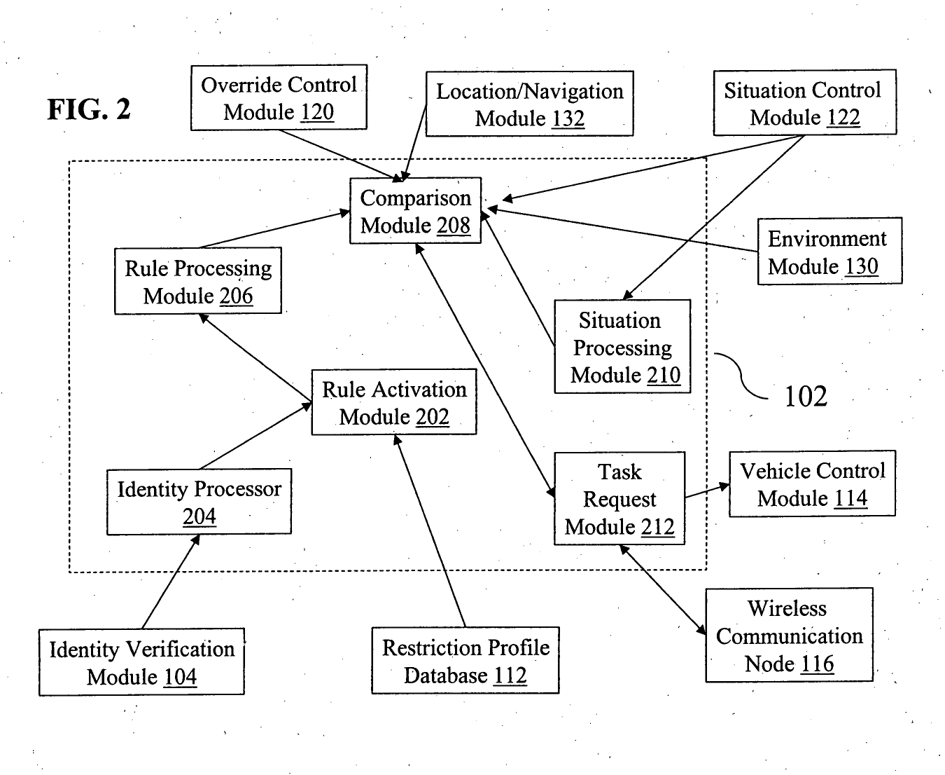

Referring to FIG. 2, in one embodiment, the central control unit 102 includes an identity processor 204, a rule activation module 202, a rule processing module 206, a comparison module 208, a situation processing module 210, and a task request module 212.

The rule activation module 202 is in communication with the identity processor 204, the rule processing module 206, and the restriction profile database 112. The identity processor 204 is in communication with the identity verification module 104.

The comparison module 208 is in communication with rule processing module 206, the override control module 120, the location/navigation module 132, the situation control module 122, the environment module 130, the situation processing module 212, and the task request module 212.

The task request module 212 is also in communication with the vehicle control module 114 and the wireless communication module 116. The situation processing module 210 is also in communication with the situation control module 122.

Referring again to FIG. 1 and FIG. 2, in one embodiment, in operation, the motor vehicle restriction control system 100 is used by an owner of a motor vehicle to restrict another driver's operation of the motor vehicle.

The owner of the motor vehicle, such as a parent, for example, logs onto the motor vehicle restriction control system 100 by entering an administrative or superuser password into the identification verification module 104 via the user interface 110 or via remote terminal capable of wirelessly communicating with the wireless communication module 116. The parent creates a restriction profile for one or more of their children, or other users of the motor vehicle. The restriction profile includes at least one motor vehicle function restriction/operating rule, such as a maximum operating speed. For example, the parent can set the vehicles maximum operating speed to 40 mph for local roads and 55 mph for highways. Parents can create a complex set of motor vehicle function restriction rules that are dependent on both the age of the driver and the particular situation that the driver is in (e.g. time of day, location, etc.). The restriction profile is stored in the restriction profile database 112 and can only be edited by someone with the administrative password.

A user of the owner's motor vehicle, such as a teenage child, for example, must identify himself before the motor vehicle can be used. The user can identify himself via the user interface 110 by entering a user ID, via the biometric interface 106 by entering fingerprints, or via the microphone 108 by speaking a user ID. The identification verification module 106 takes the entered identification information and verifies the identity of the user. Once the identity of the user is verified the identity of the user is passed to the identity processor 204, which then instructs the rule activation module 202 to retrieve a restriction profile associated with the user from the restriction profile database 112.

The rule processing module 206 passes the particular function restrictions/operating rules from the particular restriction profile to the comparison module 208. The comparison module 208 compares the particular function restrictions/operating rules with sensor input data obtained from various sensors, in real time, as the vehicle is operated. In response, the comparison module 208 sends instructions to the task request module 212, which sends instructions to the vehicle control module 114 to limit the functionality of the motor vehicle according to the particular function restrictions/operating rules. Types of sensor input data may include, but is not limited to: noise, temperature, speed, time of day, location, distance from other vehicles, and precipitation.

For example, assume the particular function restriction/operating rule limits the particular user's maximum vehicle operating speed to 40 mph for local roads and 55 mph for highways. The comparison module 208 compares this rule to input from the situation control module 122 and input from the location/navigation module 132. The situation control module 122 receives speed information from the speed sensor 136. The location/navigation module 132 receives input from the location/navigation module 132, which receives location information from the GPS 134. The comparison module 208 instructs the task request module 212 to instruct the vehicle control module 114 to limit the vehicle's maximum speed according to the particular road that the user is driving on. For example, in one embodiment, the vehicle control module 114 controls a programmable governor (similar to that used in a cruise control), which limits the vehicle's maximum speed, for example, if the vehicle is operated on a local road. In another embodiment, the vehicle control module 114 controls gas flow to the fuel injectors, which limits the vehicle's maximum speed.

The comparison module 208 also receives input from the situation processing module 210, which receives data from the situation control module 122. The situation processing module 210 interprets internal and external driving conditions and provides additional information to the comparison module 208, which then further determines how the particular function restrictions/operating rules are applied. Examples of external conditions that may be sensed include: road conditions (e.g., dry, slipping, wet, etc.), traffic (e.g., heavy, easy), people or animals crossing in front of the vehicle on the road ahead, and the distance of the vehicle from any surrounding vehicles. Examples of internal conditions that may be sensed by suitably located vehicle sensor devices include: infant crying in the vehicle, passengers talking, or a dog barking and distracting the driver, temperature in a car (e.g. too hot, too cold), a radio playing too loudly, a light on in the vehicle cabin and distracting the driver.

For example, the situation control module 122 may send information received from the distance sensor 124 to the situation processing module 210 regarding how far the vehicle is from another vehicle. The situation processing module 210 then implements an algorithm to determine that the maximum operating speed should be reduced by a certain amount to increase the distance between the two vehicles. This information is sent to the comparison module 208, which then instructions the task request module 212 to instruct the vehicle control module 114 to limit further the vehicle's maximum operating speed.

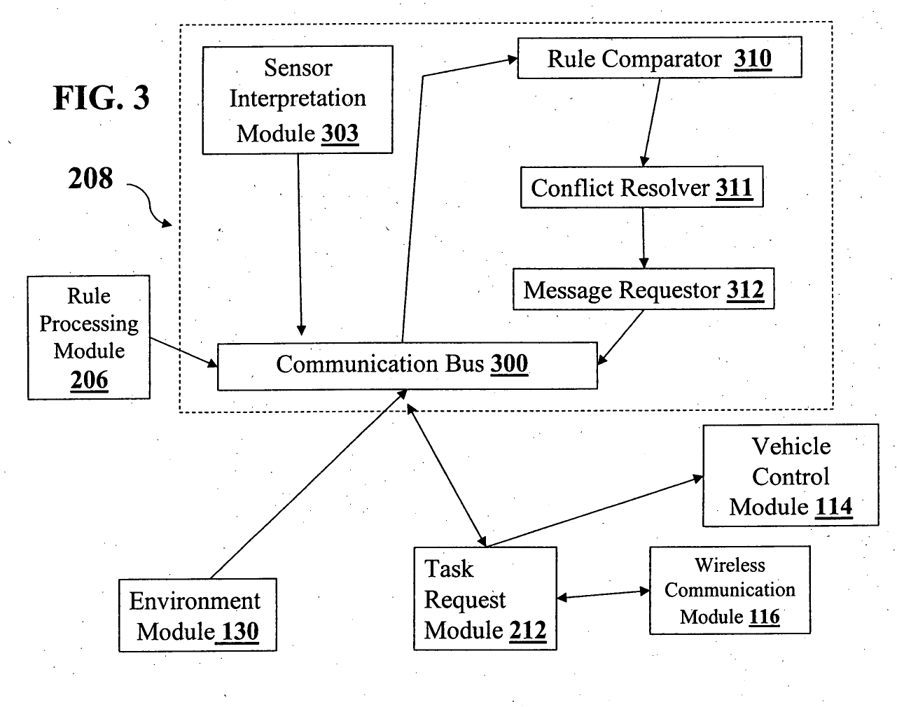

Referring to FIG. 3, in one embodiment, an illustrative block diagram of a comparison module 208 is shown. As previously described, the comparison module 208 compares the particular function restrictions/operating rules with input from various sensors and sends instructions to the task request module 212, which sends instructions to the vehicle control module 114 to limit the functionality of the motor vehicle according to the particular function restrictions/operating rules.

The comparison module 208 includes a communication bus 300, a sensor interpretation module 303, a rule comparator 310, a conflict resolver 311, and a message requestor 312.

The communication bus 300 communicates data to the rule comparator 310 in the comparison module 208 from various modules including the rule processing module 206, the override control module 120, the location/navigation module 132, the situation control module 122 (via the sensor interpretation module 303), the environment control module 130, the situation processing module 210, and the task request module 212.

The rule comparator 310 evaluates data from the various modules previously described using various algorithms and statistical methods. In particular, the rule comparator 310 compares input data with rules (associated with a particular user) from the rule processing module 206 to determine the risk of following the rules versus the risk of suspending the rules. For example, the rule comparator 310 compares the sensor data (e.g. current speed, distance from another car, weather conditions, etc.) with the restriction profile associated with the current user to ensure that the user complies with the current rules, or to determine if the current rules need to be overridden. If the current situation (data from the various sensors) conflicts with the current rules, the conflict resolver 311 is enabled. The conflict resolver 311 may resolve a conflict by temporarily suspending the rules until the situation changes. After the conflict resolver 311 resolves any conflicts between the situational data and the rules for the current driver, the conflict resolver 311 instructs the message requester 312 to send instructions to the task request module 212 via the communication bus 300. The task request module 212 then sends the instruction to the vehicle control module 114 to adjust control of the vehicle.

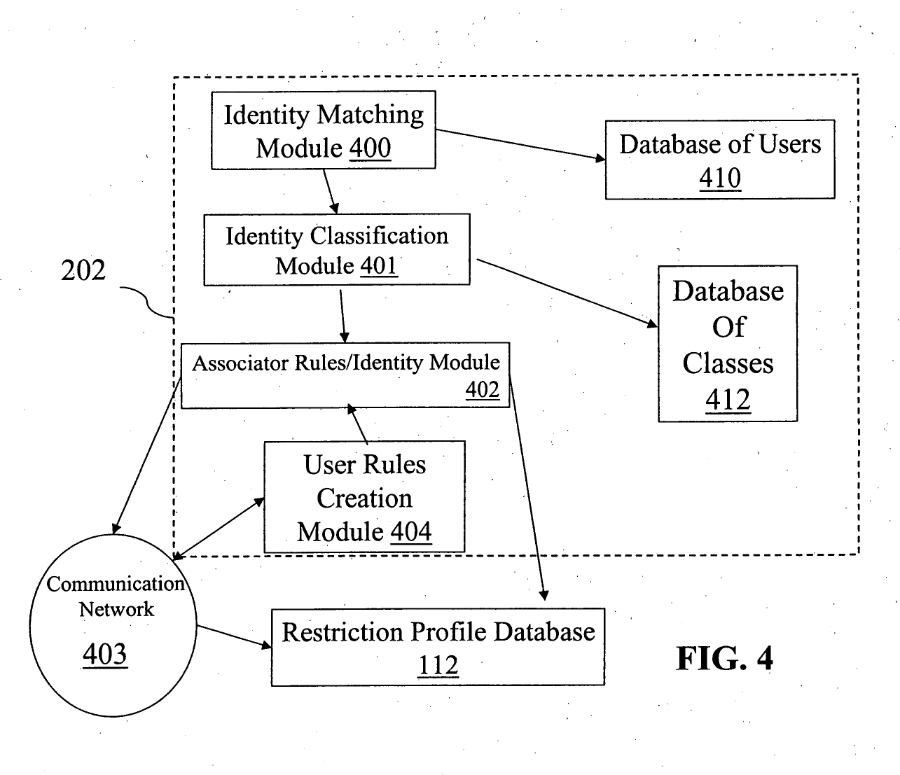

Referring to FIG. 4, in one embodiment, an illustrative block diagram of a rule activation module 202 is shown. The rule activation module 202 includes an identity matching module 400, identity classification module 401, an associator rules/identity module 402, a user rules creation module 404, a database of users 410 (parents, drivers, police, etc) and a database of classes 412.

As previously described in connection with FIG. 2, the rule activation module 202 communicates with the rule processing module 206, the identity processor 204, and the restriction profile database 112. After a user logs in via the identity verification module 104, the identity of the user is passed to the identity processor 204, which in turn passes the user's identity to the rule processing module 206. Within the rule processing module 206, the identity matching module 600 matches the user with users listed in the database of users 410. Thereafter, the identity classification module 601 determines the class of the user by checking the database of classes 412. The database of classes 412 includes characteristics associated with the class of the driver, such as age, authority level, driving history, etc. Next, the associator rules/identity module 402 retrieves from the restriction profile database 112 rules and restrictions associated with the particular user, or the particular class of user. In one embodiment, the rules and restriction are retrieved from the restriction profile database 112 directly. In another embodiment, the rules and restriction are retrieved from the restriction profile database 112 via a communication network 403, such as the internet, for example, or via a wireless communications channel or link. In one embodiment, the user rules creation module 404 creates new rules automatically for a new category of user, or for a new particular user. The basis for the automatic rules creation can, in one embodiment, be based on a preset profile default for the particular classification of user. In another embodiment, the user rules creation module 404 can be activated by a user authorized to create rules, such as a police officer or a parent.

In another example, assume the particular function restriction/operating rule limits the particular user's operation of the vehicle to between 8 a.m. and 9 p.m. The comparison module 208 compares this rule to input from the situation control module 122 and input from the location/navigation module 132. The situation control module 122 receives time information from an internal clock. The location/navigation module 132 receives location information from the GPS receiver 134. The comparison module 208 instructs the task request module 212 to instruct the vehicle control module 114 to prevent the vehicle from starting if the vehicle is located at the owner's home and it is after 9 p.m. and before 8 a.m. If the user is away from the owner's home prior to the 9 p.m. time limit and the limit passes while the vehicle is off, the comparison module 208 instructs the task request module 212 to instruct the wireless communication module 116 to contact the owner and request that the owner override the restriction. The owner, from a home computer including a wireless communication device establishes communication with the wireless communication module 116 and logs on to the vehicle restriction system 100 as previously described using an administrative password and provides an override command to the override control module 120. The override control module 120 sends the override command to the comparison module 120, which then instructs the task request module 212 to instruct the vehicle control module 114 to allow the vehicle to start. Alternatively, the user can simply call the owner and request that restriction be overridden. The owner then proceeds as described above. If the user is driving the vehicle as the time limit passes, the override control module 120 will automatically provide a restriction override command to prevent the vehicle from turning off while in use. After the vehicle is turned off, the vehicle will not be allowed to start again until an override command is sent by the owner or until the restricted operating time has passed.

In still another example, assume the particular function restriction/operating rule allows the particular user to drive only on local roads. The comparison module 208 compares this rule to input from location/navigation module 132, which receives location information from the GPS receiver 134. As long as the user drives on local roads, nothing happens. If the user drives on a highway, the comparison module 208 instructs the task request module 212 to sound an audible alarm within the vehicle cabin as long as the driver is driving on a highway. Further, the comparison module 208 also instructs the task request module 212 to instruct the wireless communication module 116 to contact the vehicle owner to inform him that the user is violating the restriction.

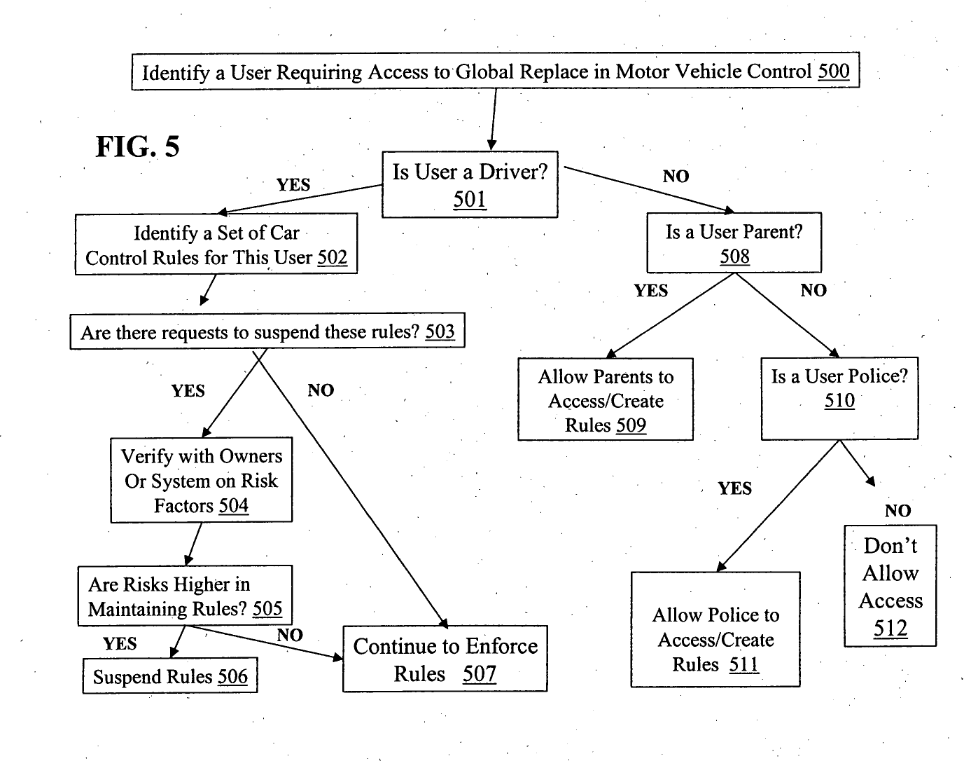

Referring to FIG. 5, in another embodiment, a flow diagram of the operation of the motor vehicle restriction control system 100 is shown. A user identifies himself via the user interface 110 or wireless communication module 116 by entering a user ID, which is passed to the identification verification module 104 (Step 500). If the user is a driver, the identity processor 204 communicates with the rule activation module 202. The rule activation module retrieves a restriction profile for the particular user from the restriction profile database 112 and passes the restriction profile to rule processing module 206, which in turn, passes the restriction profile to the comparison module 208 (Step 502). The override control module 120 monitors requests to override the rules set by the restriction profile and passes the requests to the comparison module 208 (Step 503). If there are no requests to override the rules, the rules are enforced (Step 507). If there is a request to override the rules, the comparison module 208 determines if the rules should be overridden (Step 504). The comparison module 208 either sends a request to the owner of the vehicle via the wireless communication module 116, or evaluates current conditions or risk factors, such as time of day, location of the vehicle, or weather conditions, for example (Step 505). If the comparison module 208 receives permission from the owner of the vehicle, or determines that enforcing the rules is more dangerous than overriding the rules, the comparison module 208 suspends the rules (Step 506). If the comparison module 208 does not receive permission from the owner of the vehicle, or determines that enforcing the rules is less dangerous than overriding the rules, the comparison module 208 enforces the rules (Step 507).

If the user is not a driver, the identity verification module 104 determines if the user is a parent (Step 508). If the user is a parent, the parent is given access to the restriction profile database 112 to create, edit, or suspend rules (Step 509). If the user is not a parent, the identity verification module 104 determines if the user is a police officer (Step 510). If the user is not a police officer, no access is given (Step 512). If the user is a police officer, the police officer is given access to the restriction profile database 112 to create, edit, or suspend rules (Step 511).

In another embodiment, the function restrictions/operating rules include preventing a teenager from driving the vehicle if there is another teenager or a baby in the car. The owner of the vehicle uses the situation processing module 210 to define parameters used to determine if there are other people in the vehicle besides the driver based on data received from cameras and microphones disposed within the passenger compartment. There are various techniques that can be used to identify people and objects in a vehicle. Some of these techniques are described in U.S. Pat. No. 6,611,622 entitled “Object recognition system and process for identifying people and objects in an image of a scene”, the entire contents and disclosure of which is incorporated by reference as if fully set forth herein.

In yet another embodiment, the cameras and microphones can be used to determine how many people are in the vehicle and what their ages are. Various techniques are described in U.S. Pat. No. 6,792,339, entitled “Artificial passenger with condition sensors”. Various Methods for counting people are described U.S. Pat. No. 5,656,801, entitled “System and a method for counting people”. Methods for determining the various ages of the passengers are described in U.S. Pat. No. 6,665,644, entitled “Conversational data mining using voice biometrics”. Each of the identified U.S. Pat. Nos. 6,792,339, 5,656,801, and 6,665,644 are wholly incorporated by reference herein.

In another embodiment, the system includes biometric sensors for determining if a driver is tired, stressed, or distracted. Methods for using biometrics to determine how tired, stressed, or distracted are people are described in U.S. Pat. No. 6,236,968 “Sleep prevention dialog based car system” and in U.S. Pat. No. 6,421,453 “Apparatus and methods for user recognition employing behavioral passwords”. Thus, the owner of the vehicle can define function restrictions/operating rules based on the driver's physical condition (e.g., prevent the car from operating if the driver is too tired). Each of the identified U.S. Pat. Nos. 6,236,968 and 6,421,453 are wholly incorporated by reference herein.

In still another embodiment, the system includes a function restriction/operating rule overriding means that overrides a particular restriction if there is danger. For example, the overriding means can override the particular restriction if there is danger of a collision, if the teenager needs to drive at a speed faster than maximum allowed speed for a few seconds, or if the teenager needs to drive at night.

In yet another embodiment, the system allows a police officer to edit, add, or suspend restriction/operating rules via the override control module 120 In person (via the user interface 110) or remotely (via wireless communication module 116). For example, a police officer may override a night driving restriction if the teenager needs to drive someone who is sick to a hospital.

Variations, modifications, and other implementations of what is described herein may occur to those of ordinary skill in the art without departing from the spirit and scope of the invention. Accordingly, the invention is not to be defined only by the preceding illustrative description.

What is claimed is:

1. A system for restricting a driver's operation of a motor vehicle comprising:
a driver identification module for identifying the driver operating the motor vehicle;
a storage device for storing at least one restriction profile defining for the driver at least one restriction of the operation the motor vehicle; and
a motor vehicle controlling module for restricting the operation of the motor vehicle according to the at least one restriction in response to the driver identification module identifying the driver.

2. The system of claim 1 wherein the driver identification module comprises a biometric device.

3. The system of claim 1 wherein the driver identification module comprises a voice recognition device.

4. The system of claim 1 wherein the driver identification module comprises a user interface device for entering a user name.

5. The system of claim 1 wherein the at least one restriction comprises the maximum speed at which the motor vehicle can be operated.

6. The system of claim 1 wherein the at least one restriction comprises a time of day during which the motor vehicle can be operated.

7. The system of claim 1 wherein the at least one restriction comprises a geographical location in which the motor vehicle can be operated.

8. The system of claim 1 wherein the motor vehicle controlling module comprises a speed limiting device.

9. The system of claim 1 wherein the motor vehicle controlling module comprises an ignition disabling means.

10. The system of claim 1 further comprising a global positioning system and an alarm wherein the alarm engages in response to the global positioning system determining that the motor vehicle has traveled to a restricted location.

11. The system of claim 10 wherein the alarm comprises an audible alarm located within the motor vehicle.

12. The system of claim 10 wherein the alarm comprises a wireless transmitter for transmitting a warning message to a remote wireless receiver.

13. The system of claim 1 further comprising a user interface for inputting or editing the at least one restriction profile.

14. The system of claim 1 further comprising an override module for overriding the at least one restriction during an emergency.

15. The system of claim 1 further comprising a wireless communication module for remotely inputting or editing the at least one restriction profile and for remotely overriding the at least one restriction.

16. The system of claim 1 further comprising a wireless communication module for enabling the driver to request that the at least one restriction be temporarily disabled.

17. The system of claim 8 further comprising a distance sensor for sensing the distance between the motor vehicle and another vehicle, and wherein the speed limiting device reduces the motor vehicle speed to comply with a predetermined minimum distance restriction.

18. A method for restricting a driver's operation of a motor vehicle comprising:
providing a driver identification module for identifying the driver operating the motor vehicle;
providing a storage device for storing at least one restriction profile defining for the driver at least one restriction of the operation the motor vehicle; and
providing a motor vehicle controlling module for restricting the operation of the motor vehicle according to the at least one restriction in response to the driver identification module identifying the driver.

19. A program storage device readable by a machine, tangibly embodying a program of instructions executable by the machine to perform method steps for restricting a driver's operation of a motor vehicle comprising:
providing a driver identification module for identifying the driver operating the motor vehicle;
providing a storage device for storing at least one restriction profile defining for the driver at least one restriction of the operation the motor vehicle; and
providing a motor vehicle controlling module for restricting the operation of the motor vehicle according to the at least one restriction in response to the driver identification module identifying the driver.
